(19) United States
(12) Patent Application Publication
(10) Pub. No.: US 2014/0199883 A1
(43) Pub. Date: Jul. 17, 2014

(54) Reversed Plug Orientation

(71) Applicant: Mark Medley, Covina, CA (US)

(72) Inventor: Mark Medley, Covina, CA (US)

(21) Appl. No.: 13/987,289

(22) Filed: Jan. 14, 2013

(51) Int. Cl. H01R 13/46

(52) U.S. Cl. CPC H01R 13/46
USPC 439/535

(57) ABSTRACT

Generally disclosed is an intermediary apparatus for an electric wall outlet and an electric device. Plugs are arranged on the apparatus so that a wall cannot conflict with the cord of the electric device.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of Invention

This disclosure is in the field of electrical outlet timers. More specifically, this disclosure is in the field of electrical outlet timers with reversed socket orientation.

2. Background of the Invention

Sometimes, items (e.g., timers or surge protectors) are provided intermediate to an electric device and an electrical outlet. For example, timers may be provided to an electrical outlet so that the timer can open the electrical outlet during a set time period and close the electrical outlet during other time periods. Typically, such items are plugged into the electrical outlet so that their backs are against a wall. In most cases electrical sockets are provided to the timer around the top, bottom or sides. These items may be used by coupling an electrical device to one of the sockets.

Usually, users can plug an electrical device directly into the socket of the item. However, if an electrical device has an elbow plug (a plug on a power cord with prongs that are perpendicular to the cord), then the plug cannot couple to a socket on the top, bottom or sides of the intermediate item because the cord of the elbow plug is in conflict with the wall that abuts the back of the item. The result is that the item must either be removed from the wall or fit with an extension of the plug. Thus, a need exists for electrical intermediary items that are compatible with elbow plugs.

### SUMMARY OF THE INVENTION

In view of the foregoing, it is an object of this disclosure to describe intermediate apparatus for electrical devices and electrical wall sockets that are compatible with elbow plugs. In one embodiment the intermediate apparatus comprises: a housing with a front, back, top, bottom, left side, and right side; a plug extending from the back for electrically coupling the housing to an electrical wall socket; and a socket on its left, right, top, or bottom side that is oriented away from the wall. In use, the apparatus may be coupled to a wall socket and then coupled to an electric device.

Other objectives and desires may become apparent to one of skill in the art after reading the below disclosure and viewing the associated figures.

### BRIEF DESCRIPTION OF THE FIGURES

The manner in which these objectives and other desirable characteristics can be obtained is explained in the following description and attached figures in which:

FIG. 1 is a perspective view of an intermediary between an electrical outlet and an electric device;

FIG. 2 is a front view of the intermediary shown in FIG. 1;

FIG. 3 is a back view of the intermediary shown in FIG. 1;

FIG. 4 is a right side view of the intermediary shown in FIG. 1;

FIG. 5 is a left side view of the intermediary shown in FIG. 1;

FIG. 6 is a top view of the intermediary shown in FIG. 1

FIG. 7 is a bottom view of the intermediary shown in FIG. 1;

FIG. 8 is an environmental view of the intermediary shown in FIG. 1;

FIG. 9 is another environmental view of the intermediary shown in FIG. 1; and,

FIG. 10 is another embodiment of the bottom of the intermediary shown in FIG. 1.

In the drawings, items shown in broken lines might also be drawn in solid lines.

It is to be noted, however, that the appended figures illustrate only typical embodiments of the disclosed apparatus, and therefore, are not to be considered limiting of their scope, for the disclosed systems may admit to other equally effective embodiments that will be appreciated by those reasonably skilled in the relevant arts. Also, figures are not necessarily made to scale.

### DETAILED DESCRIPTION OF PREFERRED EMBODIMENTS

Generally disclosed is an intermediary apparatus for an electric wall outlet and an electric device. Plugs are arranged on the apparatus so that a wall cannot conflict with the cord of the electric device. The more specific details of the apparatus are disclosed in further detail with reference to the drawings.

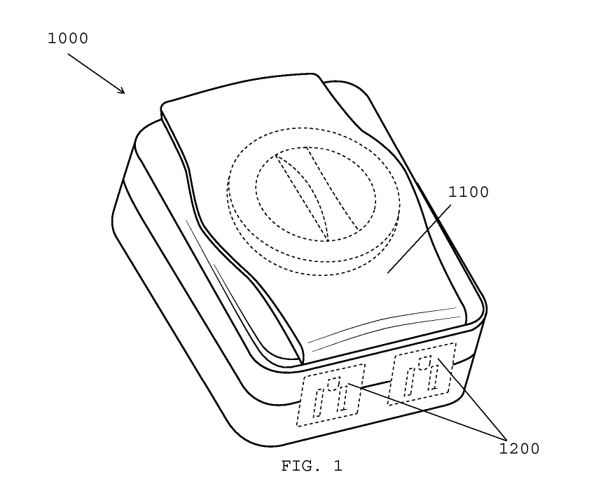

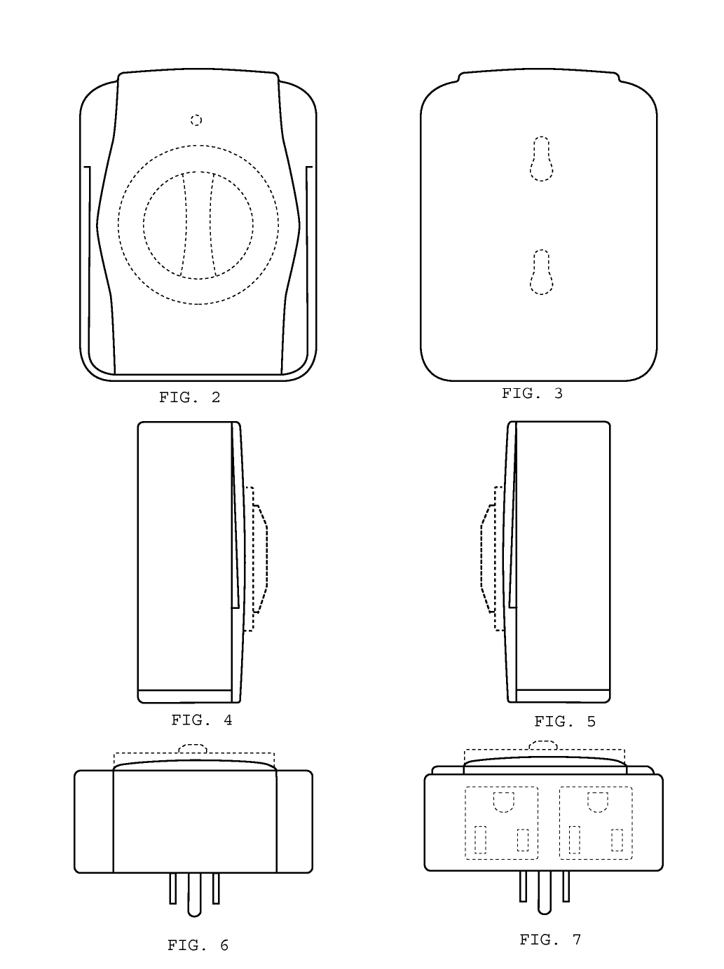

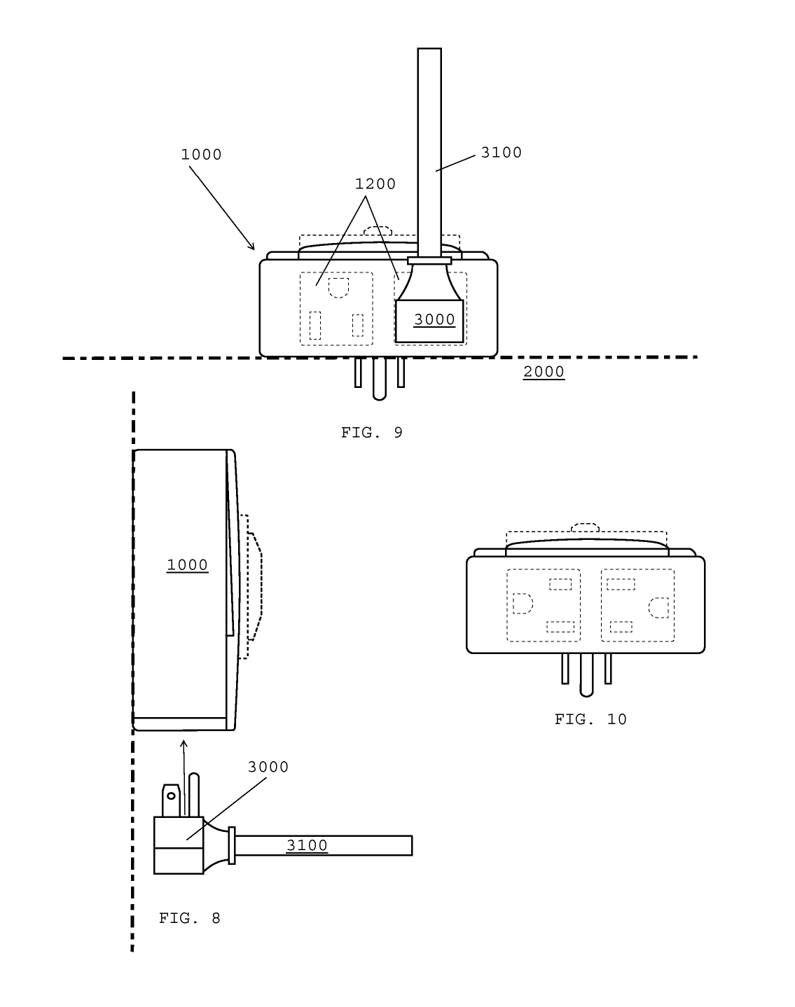

FIG. 1 through 8 respectively depict perspective, front, back, left side, right side, top, and bottom views of the disclosed intermediate apparatus 1000 for an electric device and a wall outlet. As shown, the apparatus 1000 features a block housing 1100 that is electrically coupled to two sockets 1200 on the bottom of the housing. As shown, the sockets 1200 are of the three conductor variety. Referring to FIG. 7, the orientation of the plugs is preferably outward (i.e., so that the parallel blade sockets are closer to the wall than the ground socket).

FIGS. 8 and 9 are environmental views of the apparatus 1000 plugged into a wall 2000. Together, FIGS. 8 and 9 illustrate use of the intermediate apparatus 1000. Referring first to FIG. 8, a three prong elbow plug 3000 may be directed for coupling of the plug to one of the sockets 1200 of the apparatus. As shown, the cord 3100 of the plug 3000 does not conflict with the wall 1000 when coupled to the intermediary.

FIG. 10 is another embodiment of the intermediary apparatus. As shown the sockets 1200 are rotated by ninety-degrees.

The disclosed apparatus may be constructed of any suitable materials and methodologies known for the construction of electrical intermediary apparatus. It should be noted that FIGS. 1 through 10 and the associated description are of illustrative importance only. In other words, the depiction and descriptions of the present disclosure should not be construed as limiting of the subject matter in this application. Additional modifications may become apparent to one skilled in the art after reading this disclosure. By way of summary, what is disclosed may be an electrical intermediary apparatus for an electric device and an electric wall outlet, wherein the apparatus comprises: a housing and a plug that is electrically coupled to a socket; wherein the socket is outwardly oriented.

We claim:

1. A an intermediary apparatus for an electric wall outlet and an electronic device comprising:
a housing with at least one electrical socket that is configured such that a cord of the electronic device does not conflict with a wall wherein the wall electrical wall outlet is disposed.

2. A method of facilitating the connection of an electronic device and an outlet in a wall by redirected the angle of connection, said method comprising the steps of:
Obtaining an intermediary apparatus, said apparatus defined by a housing with at least one electrical socket that is configured such that a cord of the electronic device does not conflict with the wall.

3. An electrical intermediary apparatus for an electric device and an electric wall outlet, wherein the apparatus comprises:
a. a housing; and,
b. a plug that is electrically coupled to a socket in the housing; wherein the socket is outwardly oriented with respect to the electric wall outlet.
